(19) United States
(12) Patent Application Publication
(10) Pub. No.: US 2009/0284502 A1
(43) Pub. Date: Nov. 19, 2009

(54) IMAGE SIGNAL DISPLAY CONTROL APPARATUS AND IMAGE SIGNAL DISPLAY CONTROL METHOD

(75) Inventor: Akinori Hayafuji, Yamagata (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Tendo-shi, Yamagata (JP)

(21) Appl. No.: 12/095,034

(22) PCT Filed: Dec. 7, 2006
(86) PCT No.: PCT/JP2006/324426

§ 371 Date: May 27, 2008

(30) Foreign Application Priority Data
Dec. 26, 2005 (JP) 2005-371437

(51) Int. Cl. G09G 5/10

(52) U.S. Cl. 345/205; 345/690; 345/60

(57) ABSTRACT

A video display area setting means 4 for setting up a video display area in an image displayed in a display panel 11, and a lighting rate calculation means 5 for calculating a lighting rate of a pixel in the video display area set up by this video display area setting means are provided. An image signal read from a frame memory 3 is supplied to a brightness control means 6. According to the lighting rate of the pixel calculated by the above-mentioned lighting rate calculation means 5, the brightness-control means 6 operates to perform variable control of emission brightness of the video display area displayed in the display panel 11.

### TECHNICAL FIELD

This invention relates to an image signal display control apparatus and an image signal display control method, including a control means for finding an average brightness level (APL=Average Picture Level) of the image signal to be displayed (for example, PLE (Peak Luminance Enhancement)) and controlling display brightness in an image display apparatus based on this average brightness level.

### BACKGROUND ART

For example, when displaying an image, the above-mentioned PLE control is performed in PDP (plasma display panel) etc. This PLE control operates to calculate the above-mentioned average brightness level of the image signal corresponding to the whole field or the whole frame screen, and control the display brightness level for actually displaying the image based on this average brightness level.

In this case, when the average brightness level is small (when the whole image is dark), the above-mentioned PLE control is carried out so that, by setting the display brightness level to be high, even the image signal at the same brightness level may be displayed at high brightness. On the other hand, when the average brightness level is large (when the whole picture is bright), the control is carried out to lower the display brightness level and to suppress power consumption. Since the PLE control is thus performed, it is possible to realize the low power consumption and it becomes possible to display the image with a good contrast.

As described above, the display apparatus provided with a PLE control means for finding the average brightness level APL of the image signal to be displayed and for controlling the display brightness level by this APL is disclosed in Patent Documents 1 and 2 shown below. etc.

[Patent Document 1] Japanese Patent Application Publication (KOKAI) No. H9-281927

[Patent Document 2] Japanese Patent Application Publication (KOKAI) No. 2001-175220

### DISCLOSURE OF THE INVENTION

### Problem to Be Solved by the Invention

Incidentally, in an image screen displayed by the above-mentioned display apparatus, a video display area and a non-video (still image) display area may co-exist. FIGS. 1 and 2 show an example thereof. The whole area as indicated by reference sign A shows the whole image screen displayed by the display apparatus. The area as indicated by reference sign B shows the video display area.

In other words, in the example as shown in FIGS. 1 and 2, the non-video display area shown by C outside the video display area B is formed in the shape of a frame, and an example is shown in which fixed patterns, such as an icon, are displayed in an area C under the non-video display area in the above-mentioned frame shape.

In an image display plane A arranged as shown in the above-mentioned FIGS. 1 and 2, in the case where the above-mentioned PLE control is performed, this PLE control operates based on the average brightness level (APL) corresponding to the whole field or the whole frame screen so that the display brightness level of the whole screen may be controlled. Therefore, for example, as shown in FIG. 1, in the case where the whole image plane of the video display area B is bright, the display brightness level of the whole screen is lowered and the non-video display area shown by C is controlled and displayed darkly.

Further, as shown in FIG. 2, in the case where the whole image plane of the video display area B is dark, the display brightness level of the whole screen is raised and the non-video display area shown by C is controlled and displayed brightly. In other words, the display brightness level of the non-video display area C is controlled each time according to the brightness level of the video display area B, with the result that poor views, such as flickering, are given to a user in the non-video display area.

This invention aims to provide an image signal display control apparatus and an image signal display control method, which can solve the above-mentioned technical problem generated when a display means for displaying an image in which a video display area and a non-video display area exist is arranged to perform the PLE control.

### Means to Solve the Problem

A preferable aspect of the display control apparatus in accordance with this invention made in order to solve the above-mentioned problem is an image signal display control apparatus in which pixels are arranged in respective intersecting positions where a plurality of data lines and a plurality of scanning lines intersect, and an image is displayed by selectively lighting and driving the above-mentioned pixels based on an input image signal, wherein according to a lighting rate of the pixel in the video display area within the above-mentioned displayed image, it is arranged to have a brightness control means for variably controlling emission brightness in the above-mentioned video display area.

Further, a preferable basic embodiment in the display control method in accordance with this invention made in order to solve the above-mentioned problem is an image signal display control method, in which pixels are arranged in respective intersecting positions where a plurality of data lines and a plurality of scanning lines intersect, and an image is displayed by selectively lighting and driving the above-mentioned pixels based on an input image signal, wherein a video display area setting operation of setting up a video display area in the above-mentioned displayed image, a lighting rate calculation operation of calculating a lighting rate of the pixels in the video display area which is set up by the above-mentioned video display area setting operation, and a brightness control operation of variably controlling emission brightness in the above-mentioned video display area according to the lighting rate calculated by the above-mentioned lighting rate calculation operation are implemented.

### BRIEF DESCRIPTION OF THE DRAWINGS

FIG. 1 A schematic view for explaining an example of display when PLE control is performed in the case where a video display area and a non-video display area co-exist.

FIG. 2 A schematic diagram for similarly explaining another example of the display.

FIG. 3 A block diagram showing a first example of a structure in a display control apparatus in accordance with this invention.

FIG. 4 A circuit structure diagram showing an example of a structure of a preferable pixel arranged in a display panel as shown in FIG. 3.

FIG. 5 A timing chart showing an example of a gradation control means provided by the structures as shown in FIGS. 3 and 4.

FIG. 6 A block diagram showing a second example of a structure in the display control apparatus in accordance with this invention.

FIG. 7 A schematic view for explaining an example of divisions of the video display area and the non-video display area.

FIG. 8 A schematic view for similarly explaining another example of the divisions.

FIG. 9 A block diagram showing a third example of a structure in the display control apparatus in accordance with this invention.

FIG. 10 A block diagram similarly showing a fourth example of a structure.

FIG. 11 A circuit structure diagram showing an example of a structure of the preferable pixel arranged in the display panel as shown in FIG. 10.

FIG. 12 A timing chart showing an example of the gradation control means provided by the structures as shown in FIGS. 10 and 11.

FIG. 13 A block diagram showing an example of a structure of an elimination timing signal generation means suitably adopted in the structure as shown in FIG. 10.

### DESCRIPTION OF REFERENCE SIGNS

1: controller circuit
2: A/D conversion unit
3: image signal memory
4: video display area setting means
5: lighting rate calculation means
6: brightness control means
8: elimination timing signal generation means
11, 31: display panels
12: pixel
13, 33: scanning drivers
13, 32: data drivers
15: elimination driver (light putting-out scanning means)
16: power supply circuit
21: scanning line
22: data line
23: elimination signal line
24: cower supply line
A: image screen
B: video display area
C: non-video (still image) display area
C1: capacitor for holding electric charge
E1, E11-Enm: EL element (light emitting element)
EF1: constant voltage source
EV1: variable voltage source
Ia1-Ian: constant current sources (first group)
Ib1-Ibn: constant current sources (second group)
Tr1: data write-in transistor
Tr2: lighting and driving transistor
Tr3: elimination transistor

### BEST MODE FOR IMPLEMENTING THE INVENTION

Hereafter, an image signal display control apparatus and an image signal display control method in accordance with this invention will be described with reference to the preferred embodiments as shown in the drawings. It should be noted that a display panel using a light emitting element represented by an organic electroluminescence (electroluminescence) element as a display pixel will be described hereafter with reference to an example in which lighting control is carried out.

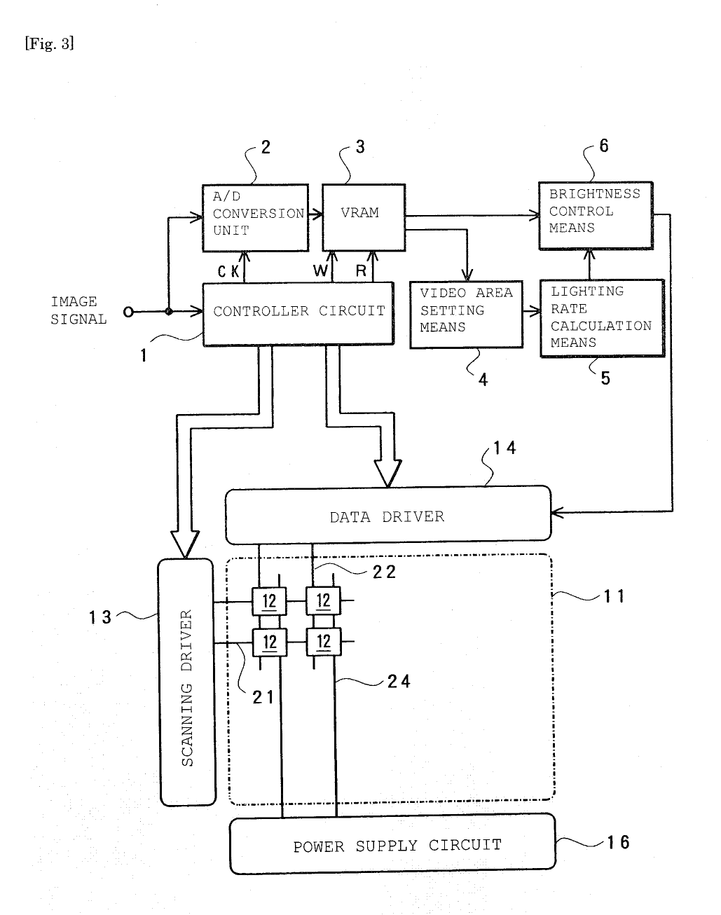

FIG. 3 shows a first embodiment thereof and shows an example of the display control apparatus for an active-matrix type display panel.

As shown in FIG. 3, a controller circuit 1 is connected with an analog/digital (A/D) conversion unit 2, and an image signal memory (hereafter may be referred to as VRAM) 3. An input image signal by an analog image signal is arranged to be supplied to the controller circuit 1 and the A/D conversion unit 2.

Based on horizontal and vertical synchronization signals in an analog image signal, the above-mentioned controller circuit 1 generates a clock signal CK for the above-mentioned A/D conversion unit 2, a write-in signal W, and a read-out signal R for the above-mentioned VRAM3.

Based on the clock signal CK supplied from the controller circuit 1, the above-mentioned A/D conversion unit 2 samples the inputted analog image signal and acts to convert this into an image data for each pixel to be supplied to VRAM3. The above-mentioned VRAM3 operates so that the image datum supplied from the A/D conversion unit 2 by the write-in signal W from the above-mentioned controller circuit 1 may be written into VRAM3 one by one.

As an example of the above-mentioned VRAM3, a frame memory is used, and the image signal for one screen in the display panel (to be described later) is written by the above-mentioned write-in operation. Further, the image signal written into VRAM3 is read in response to the read-out signal R from the above-mentioned controller circuit 1, and arranged to be supplied to a video display area setting means 4 and the brightness control means 6. It should be noted that, in FIG. 3, a video area setting means is represented by a video display area setting means 4.

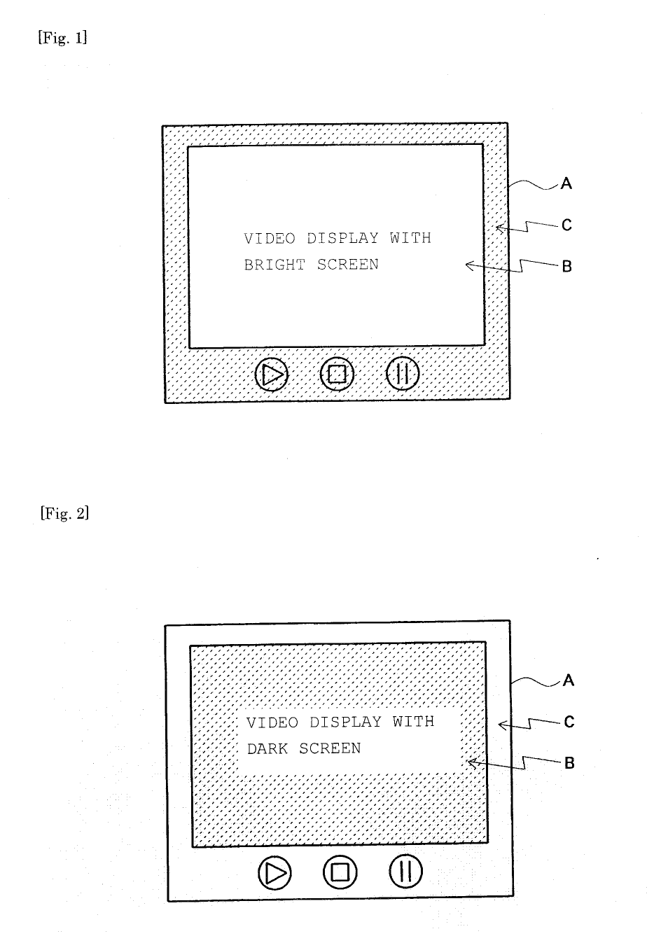

As the above-mentioned video display area setting means 4, it is possible to suitably employ a structure provided with two different functions according to a way of displaying the image in the display panel (to be described later). An example of such is a case where the video display area B and the non-video display area C in an image display plane A are always determined as shown in FIGS. 1 and 2, and neither area changes. In this case, the above-mentioned video display area setting means 4 is arranged such that a predetermined video display area may be specified in terms of each of the above-mentioned pixels. in other words, the video display area setting means 4 operates so that the image data from VRAM3 corresponding to the predetermined video display area B may be extracted and supplied to a lighting rate calculation means 5 (to be described later).

Further, another example is a case where the video display area B and the non-video display area C change with the input image signals in the image display plane A as shown in FIGS. 1 and 2. In this case, the above-mentioned video display area setting means 4 is arranged such that each time the above-mentioned video display area is detected by detecting a time change of the input image signal corresponding to each of the above-mentioned pixels, the video display area is specified in terms of each of the above-mentioned pixels. In other words, the video display area setting means 4 in this case operates so that the image signal from VRAM3 corresponding to the video display area B which is set up by detecting the time change of the input image signal may be extracted and supplied to the lighting rate calculation means 5 (to be described later).

It should be noted that the above-mentioned video display area setting means 4 may set an area other than the above-mentioned still image area i.e., the video display area, by detecting the non-video display area (still image area) in the case of the latter as described above.

The image signal from VRAM3 corresponding to the video display area from the above-mentioned video display area setting means 4 is supplied to the lighting rate calculation means 5, and this lighting rate calculation means 5 operates so that the lighting rate on a pixel by pixel basis may be calculated based on the image signal corresponding to the video display area. It should be noted that the above-mentioned lighting rate calculation means 5 can obtain a result equivalent to the function to calculate the average brightness level (APL) of the already explained image signal corresponding to the video display area.

The data of the lighting rate in the video display area obtained by the above-mentioned lighting rate calculation means 5 is supplied to the brightness control means 6. As described above, this brightness control means 6 is arranged to be supplied with the image data read from VRAM3. The above-mentioned brightness control means 6 performs an image signal conversion process of changing a gradation value of an image signal corresponding to a video display among the image signals read from VRAM3 based on the above-mentioned lighting rate.

In other words, the brightness control means 6 operates to carry out the process of converting the image signal which contributes to the video display among the image signals read from VRAM3 into the gradation value corresponding to the brightness according to the lighting rate of the pixel calculated by the above-mentioned lighting rate calculation means 5, to thereby realize PLE control for controlling the emission brightness of each pixel, in the video display area, arranged by the display panel (to be described later). The brightness control means 6 converts the above-mentioned image signal subjected to the gradation control by the PLE control into a signal form which can be driven in the data driver (to be described later) and outputs it.

It should be noted that the above-mentioned controller circuit 1 is arranged to generate a shift clock signal, a start pulse, etc., for a scanning driver 13 and a data driver 14 (to be described later) based on the above-mentioned horizontal and vertical synchronization signals in the image signal, and supply them to the drivers 13 and 14 respectively.

Reference numeral 11 as shown in FIG. 3 indicates a display panel in which a large number of pixels 12 each including the light emitting element provided with the above-mentioned organic EL element are arranged in the shape of a matrix. In this display panel 11, scanning lines 21 and data lines 22 which are respectively connected to the scanning driver 13 and the data driver 14, are arranged in mutually orthogonal directions, and the pixels 12 including the above-mentioned light emitting element are arranged in the intersecting positions respectively. It should be noted that each of the above-mentioned pixels 12 is arranged such that a voltage for lighting and driving the pixel may be supplied from the power supply circuit 16 through a power supply line 24.

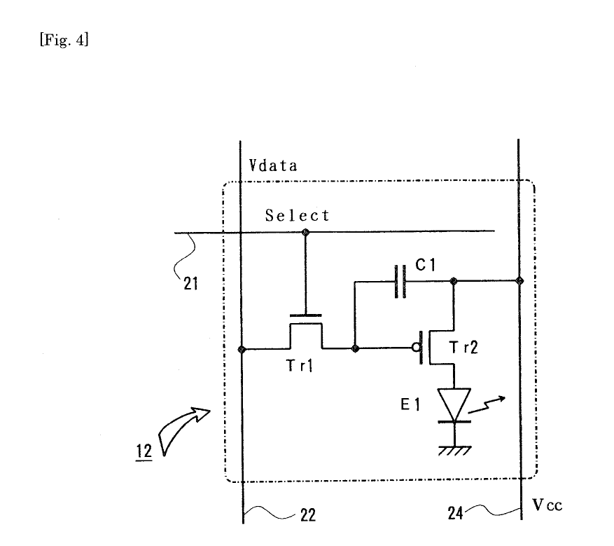

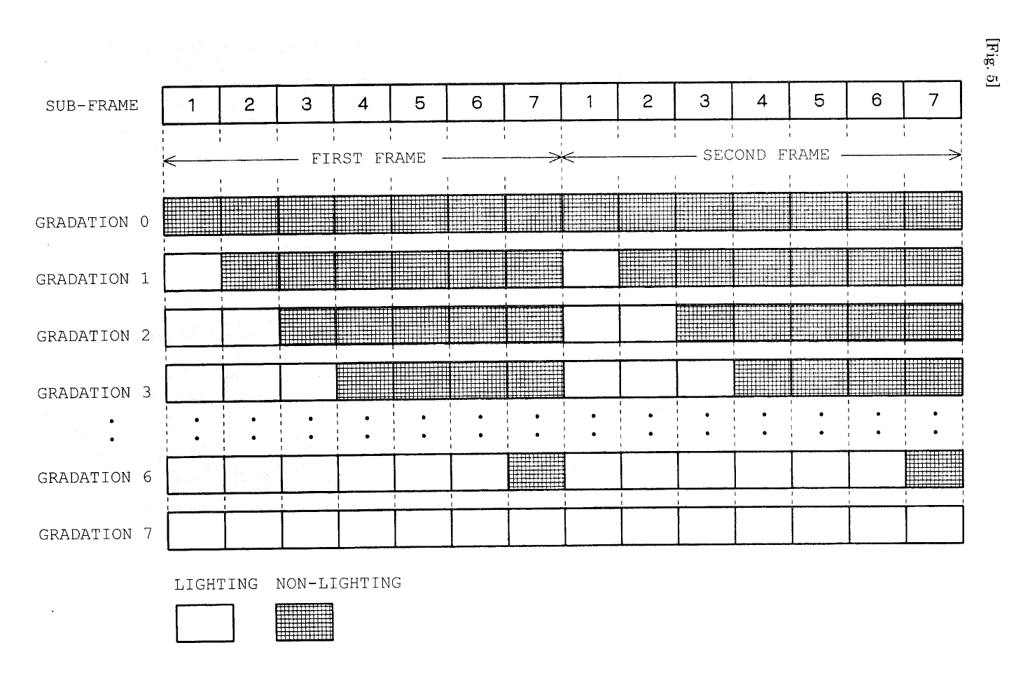

FIG. 4 shows a circuit structure corresponding to one pixel arranged at the above-mentioned display panel 11, and illustrates the most fundamental pixel structure in the case of using the organic EL element as the light emitting element. This pixel 12 is arranged so that a data signal Vdata corresponding to the image signal from the above-mentioned data driver 14 may be supplied to a source of TFT for control, i.e., a data write-in transistor Tr1, through the data line 22 arranged at the display panel.

It is arranged that a gate of the above-mentioned data write-in transistor Tr1 is supplied with a scanning signal Select (which may also be referred to as write-in pulse) through the scanning line 21 connected to the scanning driver 13. A drain of the above-mentioned data write-in transistor Tr1 is connected with a gate of a lighting and driving TFT, i.e., a lighting and driving transistor Tr2, and connected with one terminal of a capacitor C1 for maintaining electric charge.

Further, it is arranged that a source of the lighting and driving transistor Tr2 is connected with the other terminal of the above-mentioned capacitor C1, and is supplied with a drive voltage Vcc from the above-mentioned power supply circuit 16 through the power supply line 24. A drain of the above-mentioned lighting and driving transistor Tr2 is connected with an anode terminal of an organic EL element E1 as the light emitting element, and a cathode terminal of this organic EL element E1 is connected with a reference potential point (ground) of the display panel.

It should be noted that, in the circuit structure of the pixel 12 as shown in FIG. 4, the data write-in transistor Tr1 is constituted by an n-channel type TFT, and the drive transistor Tr2 is constituted by a p-channel type TFT. As shown in FIG. 3, a large number of the pixels 12 having the above-mentioned structure are arranged in the shape of a matrix in row and column directions, to constitute the display panel 11.

In the structure of the pixel 12 as shown in FIG. 4, the write-in pulse Select as the scanning signal is supplied from the scanning driver 13 to the gate of the control transistor Tr1 during an address period. At this time, in the case where the data signal Vdata supplied from the data driver 14 are data for turning on the pixel, the current corresponding to the data signal Vdata flows into the capacitor C1 through the source and drain of the control transistor Tr1, and the capacitor C1 is charged.

Then, the thus charged voltage is supplied to the gate of the drive transistor Tr2, and the transistor Tr2 applies its gate voltage and the current corresponding to the drive voltage Vcc supplied to the drain, to the above-mentioned EL element E1, whereby the EL element E1 emits light (lighting).

If application of the above-mentioned write-in pulse to the gate of the above-mentioned control transistor Tr1 is stopped, the transistor Tr1 is so-called cut off. However, the gate voltage of the drive transistor Tr2 is held by the electric charge accumulated in the capacitor C1, whereby the drive current to the EL element E1 is maintained.

Therefore, the EL element E1 can continue a lighting state corresponding to the above-mentioned data signal Vdata during the period until the next address operation. Thus, in the above-mentioned address period, according to the data signal Vdata supplied from the data driver 14, the lighting or putting out light of the pixel is controlled, whereby a lighting period in a unit period for each pixel is controlled individually, and gradation control is realized.

In the preferred embodiment as shown in FIGS. 3 and 4, in order to realize gradation expression by the above-mentioned PLE control, a control means is employed in which one frame period is divided into a plurality of sub-frames, the lighting or non-lighting of the pixel for every sub-frame is controlled, and the lighting periods of the pixels within one frame period are summed, to thereby realize gradation control.

FIG. 5 shows an example of the gradation control. In this example, in order to simplify the description, a simple sub-frame method is shown in which one frame period is divided into seven sub-frames, and sub-frame periods are simply summed to express eight gradations, “gradation 0” to “gradation 7”. In this example, the data signal Vdata which controls the pixel so as to be lighting or non-lighting is supplied from the above-mentioned data driver 14 for every sub-frame period at the time of starting the sub-frame period.

Now, in the case where the data signal for controlling the pixel to be non-lighting is supplied in all the first to seventh sub-frames which constitute one frame period, “gradation 0” is realized as shown in FIG. 5. Further, in the case where the data signal for controlling the pixel to be in the lighting state is supplied in all the first to seventh sub-frames, “gradation 7” is realized as shown in FIG. 5.

As already described, according to the lighting rate of the pixel corresponding to the video display area, the above-mentioned brightness control means 6 controls the gradation of the pixel in the video display area, and operates the control to lower the gradation in the case where the lighting rate is large. Thus, in a situation where the lighting rate of the pixels corresponding to the video display area is near 100%, it operates to lower the gradation by “n” steps (n is an integer) with respect to the gradation based on the image signal inputted. Therefore, in the case where the above-mentioned lighting rate is high, the lighting period in one frame period of the pixel in the video display area is reduced, and the emission brightness of the pixel is suppressed. As a result, it is possible to realize the low power consumption.

On the other hand, in the case where the lighting rate of the pixel corresponding to the video display area is small, it operates to raise the gradation of the video display area by “n” steps (n is an integer) with respect to the gradation based on the image signal inputted. Thus, an accumulated lighting period in one frame period of the pixel in the video display area is expanded, and it is possible to display an image with good contrast in the video display area. It should be noted that, according to the above-mentioned preferred embodiment, since the PLE operation is not performed in the non-video (still image) area, the gradation of the non-video area is displayed by the gradation based on the input image signal.

Next, other PLE control operations can also be realized by means of the structure of the display control apparatus as shown in the above-mentioned FIGS. 3 and 4.

The above-mentioned brightness control means 6 in this preferred embodiment is characterized in that it is arranged such that an output voltage value from the data driver 14 supplied to each data line corresponding to a video display area may be variably controlled according to the lighting rate of the pixel in the video display area obtained by the lighting rate calculation means 5.

In this case, the data write-in transistor Tr1 and the lighting and driving transistor Tr2 in the pixel structure as shown in FIG. 4 are set up to operate in an analog operation (constant current drive) area. In each address period corresponding to each scanning line 21, it is arranged that the voltage value of the data signal Vdata from the data driver 14 supplied to each data line corresponding to the video display area may be variably controlled according to the lighting rate obtained by the above-mentioned lighting rate calculation means 5.

As a result, in each address period corresponding to each scanning line 21, the voltage value written into the capacitor C1 for maintaining electric charge of each pixel corresponds to the voltage value of the above-mentioned data signal Vdata. Then, the lighting and driving transistor Tr2 operates to supply the above-mentioned EL element E1 with the drive current corresponding to the voltage value written into the capacitor C1 for maintaining electric charge. Therefore, the PLE operation is realized in which the brightness of each pixel 12 corresponding to the video display area is variably controlled according to the lighting rate obtained by the above-mentioned lighting rate calculation means 5.

In this case, in each address period corresponding to each scanning line 21, the voltage value of the data signal Vdata from the data driver 14 supplied to each data line corresponding to the non-video display area is controlled based on the input image signal regardless of the above-mentioned lighting rate. Therefore, the emission brightness of the pixel in the non-video area can avoid the problem that it is influenced by the above-mentioned lighting rate.

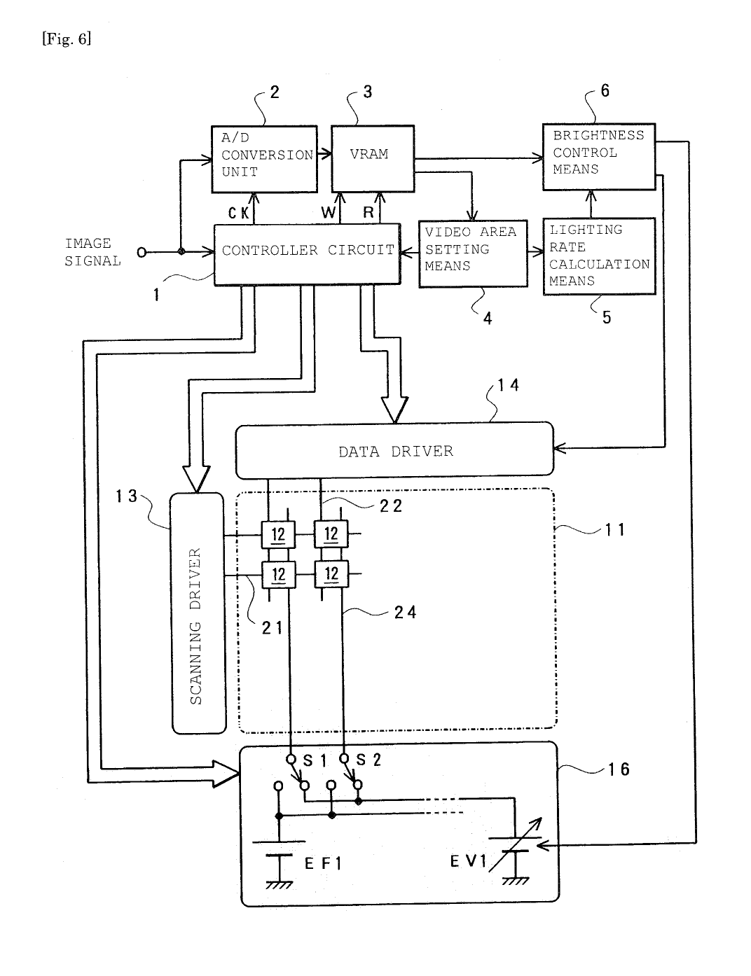

FIG. 6 shows an example of another display control apparatus in accordance with this invention. It should be noted that in a structure as shown in FIG. 6, like reference signs indicate like parts which achieve functions similar to those of the respective parts as shown in already explained FIG. 3, therefore the detailed description thereof will be omitted. Further, also in the structure of the display control apparatus as shown in FIG. 6, the structure of each pixel 12 arranged at the display panel 11 can adopt the structure as shown in FIG. 4.

The brightness control means 6 in the preferred embodiment as shown in this FIG. 6 is characterized by supplying the power supply line 24 connected to the pixel corresponding to the video display area with the drive voltage which is varied according to the lighting rate of the pixel in the video display area obtained by the lighting rate calculation means 5, and supplying the power supply line 24 connected to the pixel corresponding to the non-video display area with the drive voltage of a predetermined value.

For this reason, the above-mentioned power supply circuit 16 is provided with a variable voltage source EV1 where the output value is varied with the brightness control (PLE control) data from the brightness control means 6, and a constant voltage source EF1 where a voltage of a predetermined value is outputted. Further, corresponding to the respective power supply lines 24, switches S1, S2, . . . are provided as selection means for selectively supplying the respective power supply lines 24 with the drive voltage from the above-mentioned variable voltage source EV1 or the constant voltage source EF1.

Further, as shown in FIG. 6, information data of the video display area set up by the video display area setting means 4 are arranged to be supplied to the controller circuit 1. Receiving the information data of the above-mentioned video display area, the above-mentioned controller circuit 1 controls each of the above-mentioned switches S1, S2, . . . in the power supply circuit 16, to be selectively connected with the above-mentioned variable voltage source EV1 or constant voltage source EF1 side.

In other words, based on the information on the video display area from the above-mentioned video display area setting means 4, it operates so that the power supply line 24 corresponding to the pixel in the video display area may be supplied with the drive voltage from the variable voltage source EV1 through each of the above-mentioned switches S1, S2, . . . , and operates so that the power supply line 24 corresponding to the pixel of the non-video display area may be supplied with the drive voltage from the constant voltage source EF1 through each of the above-mentioned switches S1, S2, . . . .

Therefore, each pixel 12 in the video display area is supplied with the drive voltage from the variable voltage source EV1 where the output value is varied with the brightness control data from the brightness control means 6, whereby the PLE operation is realized in which the brightness of each pixel 12 corresponding to the video display area is variably controlled according to the lighting rate obtained by the above-mentioned lighting rate calculation means 5. On the other hand, since each pixel 12 of the non-video display area is supplied with the drive voltage from the constant voltage source EF1, each pixel 12 corresponding to the non-video display area can be maintained at constant brightness.

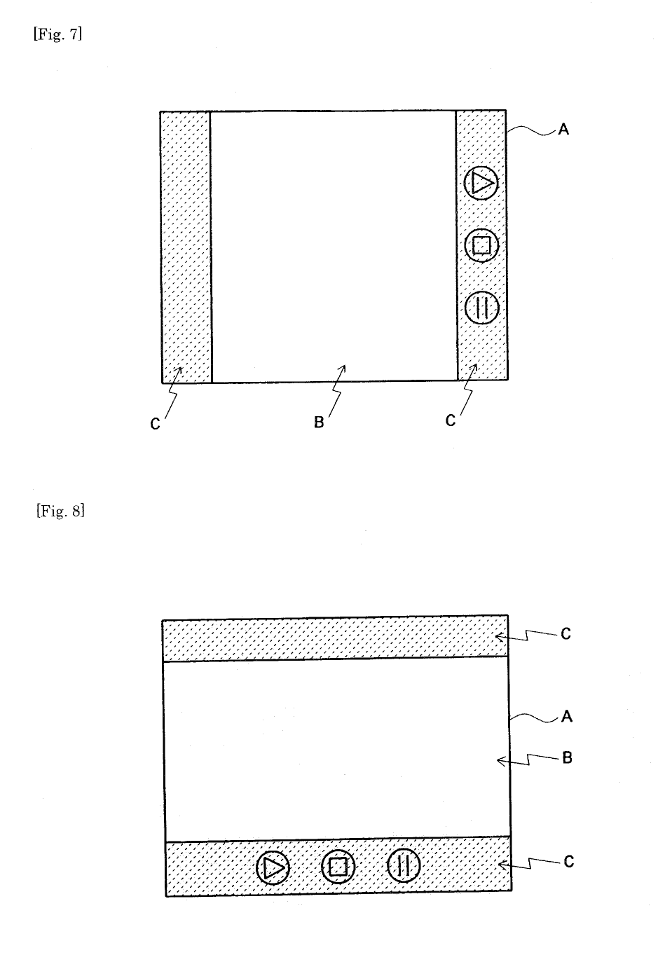

In addition, according to the preferred embodiment as shown in FIG. 6, the video display area and the non-video display area are divided in the arrangement direction of the power supply lines 24 in the display panel 11. In other words, as with the display panel 11 as shown in FIG. 6, in the case where the arrangement direction of the power supply lines 24 is a vertical direction, the video display area B and the non-video display area C are divided along a line in the vertical direction in the display plane A as shown in FIG. 7.

Therefore, configuration of the scanning lines 21, the data lines 22, and the power supply lines 24 which are shown in FIG. 6 is arranged to be rotated by 90 degrees (for example) as it is on the display panel 11, whereby the video display area B and the non-video display area C may be arranged to be divided along a line in a horizontal direction in the display plane A as shown in FIG. 8.

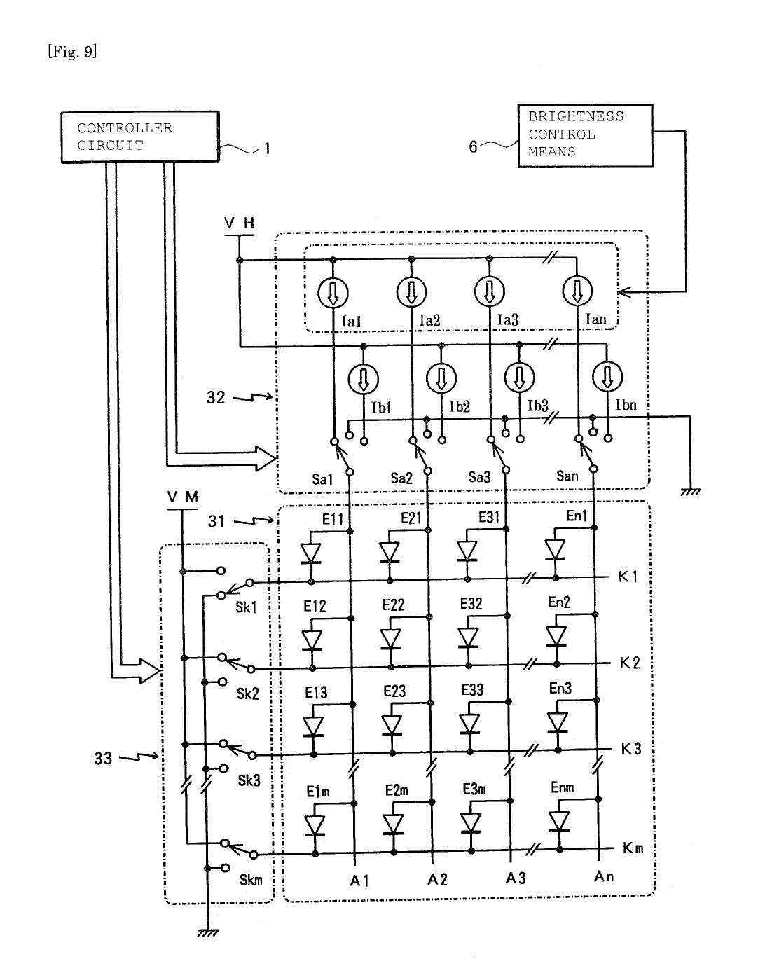

FIG. 9 shows an example of another display control apparatus in accordance with this invention, and this shows an example of the display control apparatus for a passive matrix type display panel.

Also in the structure of the display control apparatus as shown in this FIG. 9, the controller circuit 1, the A/D conversion unit 2, VRAM3, the video display area setting means 4, the lighting rate calculation means 5, and the brightness control means 6 are provided like the structure as shown in already explained FIG. 6, however FIG. 9 shows only the controller circuit 1 and the brightness control means 6, and omits the above-described remaining structure.

The brightness control means 6 in the preferred embodiment as shown in this FIG. 9 is characterized by supplying the data line connected to the pixel corresponding to the video display area with the drive current which is varied according to the lighting rate of the pixel in the video display area obtained by the lighting rate calculation means 5, and supplying the data line connected to the pixel corresponding to the non-video display area with the drive current of a predetermined value.

Anode lines A1-An as n data lines are arranged at a display panel 31 as shown in FIG. 9 in the vertical direction (column direction). Cathode lines K1-Km as m scanning lines are arranged in the horizontal direction (row direction), and the organic EL elements E11-Enm which constitute the pixels shown by a diode symbol mark are arranged to be connected to the respective intersecting portions (n×m positions in total) between the respective anode lines and scanning lines. Further, each of the anode lines A1-An is connected with an anode-line drive circuit 32 as the data driver, and each of the cathode lines K1-Km is similarly connected with a cathode-line scanning circuit 33 as the scanning driver, and they are each driven.

The above-mentioned anode-line drive circuit 32 is provided with a first group of constant current sources Ia1-Ian which operate by means of a drive voltage VH. A signal based on the PLE control from the above-mentioned brightness control means 6 is supplied to the first group of constant current sources Ia1-Ian. Thus, according to the lighting rate of the pixel in the video display area obtained by the already-described lighting rate calculation means 5, the first group of constant current sources Ia1-Ian operate so that the output current value (drive current value) may be controlled.

On the other hand, the anode-line drive circuit 32 is provided with a second group of constant current sources Ib1-Ibn, which are arranged to supply the drive current of the predetermined value. Drive switches Sa1-San as selection means which can select the above-mentioned first group or second group of constant current sources, or the ground as the reference potential point, are provided corresponding to the respective anode lines A1-An These drive switches Sa1-San are arranged so that they may be switched by a command signal from the controller circuit 1.

Further, the above-mentioned cathode-line scanning circuit 33 is provided with the scanning switches Sk1-Skm corresponding to the respective cathode lines K1-Km, and it acts so that either a reverse bias voltage source VM for preventing cross talk luminescence which functions as a non-scanning selection potential or the ground potential which functions as a scanning selection potential may be connected to corresponding cathode lines by means of the command signal from the controller circuit 1.

Thus, periodically setting the cathode lines as the reference potential point (ground potential), it acts so that the first group or second group of constant current sources are connected to desired anode lines A1-An, to thereby cause the above-mentioned respective EL elements to emit light selectively.

It should be noted that in the preferred embodiment as shown in FIG. 9, a scanning synchronization signal is supplied from the controller circuit 1 to the cathode-line scanning circuit 33, whereby operation of setting the respective cathode lines K1-Km as the ground potential (scanning selection potential) one by one is repeated. Further, synchronizing with the scanning synchronization signal, a drive control signal is supplied from the controller circuit 1 to the anode-line drive circuit 32 for every scanning line.

In other words, as already described with reference to FIG. 6, the information data of the video display area set up by the video display area setting means 4 is supplied to the controller circuit 1. In the case where the pixels in the video display area are lit based on this, the controller circuit 1 controls the drive switches Sa1-San to choose the first group of constant current sources Ia1-Ian. In the case of where the pixels of the non-video display area are lit, it controls the drive switches Sa1-San to choose the second group of constant current sources Ib1-Ibn. Furthermore, in the case of causing the pixels to be non-lighting, it controls the drive switches Sa1-San to choose the reference potential (ground potential).

Therefore, each pixel (EL element) in the video display area is supplied with the drive current from the first group of constant current sources Ia1-Ian where the constant current value is varied with the brightness control (PLE control) data from the brightness control means 6. Thus, the PLE operation is realized in which the brightness of each pixel corresponding to the video display area is variably controlled according to the lighting rate obtained by the already-described lighting rate calculation means 5. On the other hand, since the constant drive current from the first group of constant current sources Ia1-Ian is supplied to each pixel in the non-video display area, the brightness of each pixel corresponding to the non-video display area can be maintained at the constant brightness.

It should be noted that, also in the preferred embodiment as shown in FIG. 9, the video display area and the non-video display area are divided in the arrangement direction of the anode lines A1-An as the data lines in the display panel 31. In other words, in the case where the arrangement direction of the anode lines A1-An is the vertical direction like the display panel 31 as shown in FIG. 9, the video display area B and the non-video display area C are divided along the line in the vertical direction in the display plane A as shown in FIG. 7.

Therefore, configuration of the data lines A1-An and the scanning lines K1-Km, which are in an orthogonal relationship and shown in FIG. 9 is arranged to be rotated by 90 degrees (for example) as it is on the display panel 31, whereby the video display area B and the non-video display area C may be arranged to be divided along a line in the horizontal direction in the display plane A as shown in FIG. 8.

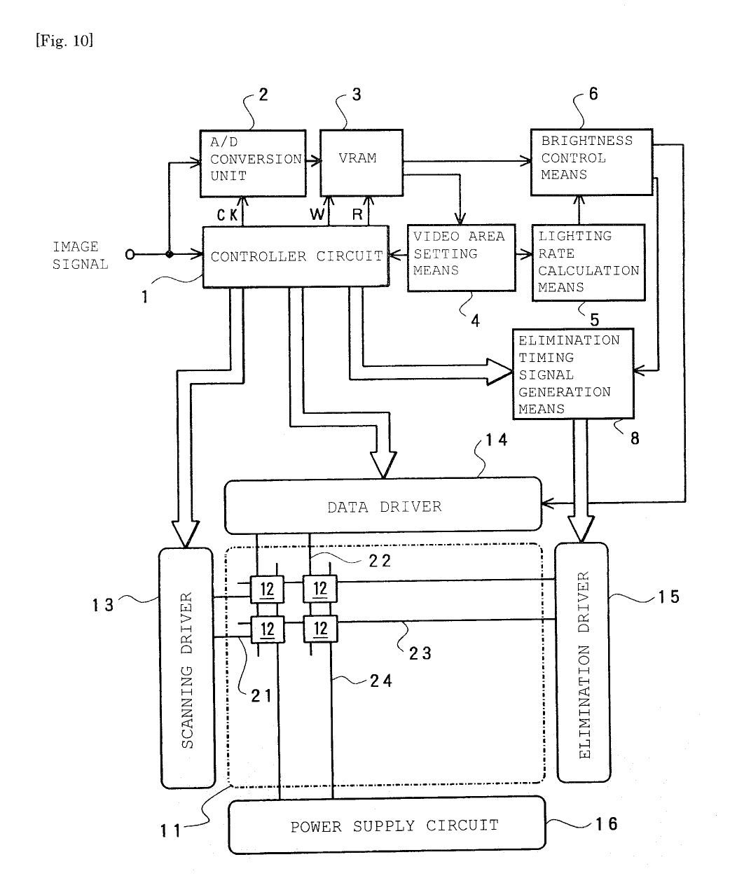

FIGS. 10-13 show an example of still another display control apparatus in accordance with this invention, and these show an example of the display control apparatus for an active-matrix type display panel which employs an SES (Simultaneous Erasing Scan) drive system.

It should be noted that in a structure as shown in FIG. 10, like reference signs indicate like parts which achieve functions similar to those of the respective parts as shown in already explained FIG. 6, therefore the detailed description thereof will be omitted.

In the preferred embodiment as shown in these FIGS. 10-13, there is provided a light putting-out scanning means for controlling the pixel to be lit and corresponding to the video display area to be in a situation where it is not lit (light is put out) in the middle of one frame or one sub-frame period. The brightness control means 6 is characterized by controlling the timing of light putting-out operation in the above-mentioned light putting-out scanning means according to the lighting rate of the pixel in the video display area obtained by the lighting rate calculation means 5.

In the structure as shown in FIG. 10, in order to realize the above-mentioned operation, an elimination driver 15 which functions as the elimination timing signal generation means 8 and the above-mentioned light putting-out scanning means is provided in addition to the structure as shown in already explained FIG. 6. According to the synchronization signal from the controller circuit 1 and the brightness control (PLE control) data from the brightness control means 6, the above-mentioned elimination timing signal generation means 8 operates to adjust an output timing of an elimination control signal (elimination pulse). It should be noted that this elimination timing signal generation means 8 will be described in detail later with reference to FIG. 13.

On the other hand, receiving the timing signal from the elimination timing signal generation means 8, the above-mentioned elimination driver 15 functions to cause the pixel 12 to be put out in the middle of one frame or one sub-frame period. In other words, elimination signal lines 23 are arranged at the display panel 11 corresponding to the scanning lines 21 of the respective pixels 12. By supplying the elimination pulse to this elimination signal line 23, it operates to turn off the pixel corresponding to the elimination signal line 23.

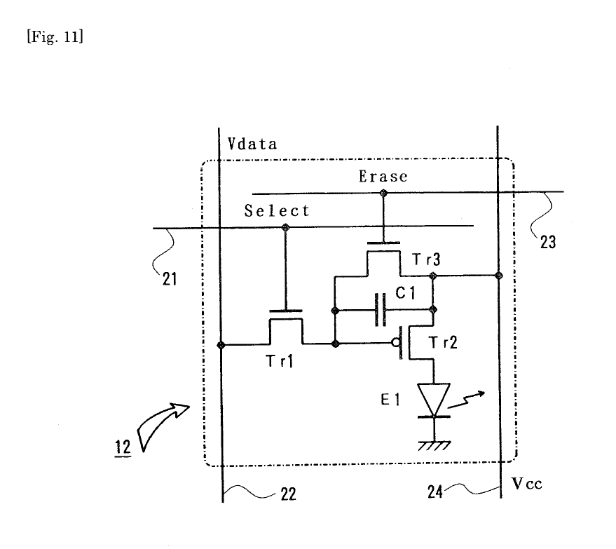

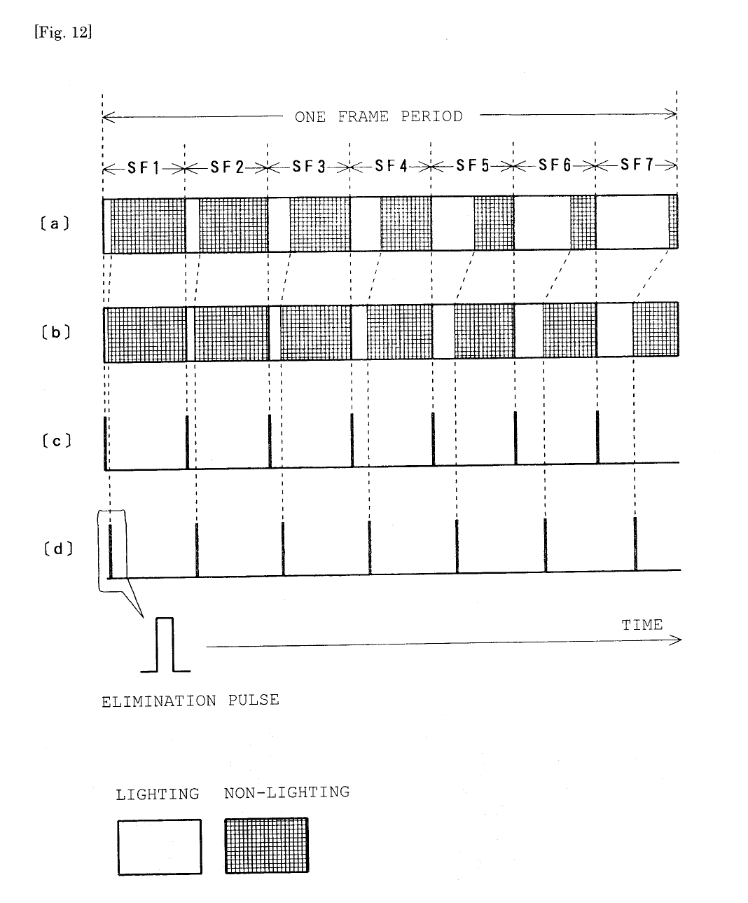

FIG. 11 shows an example of a structure of the pixel suitably employed in the above-mentioned SES drive system. The example of the structure of the pixel as shown in this FIG. 11 is further provided with an elimination transistor Tr3 of TFT in addition to the structure of the pixel as shown in FIG. 4. It is arranged that a source and a drain of the elimination transistor Tr3 are respectively connected with two ends of the capacitor C1 for maintaining electric charge, and its gate is supplied with an elimination pulse Erase from the elimination driver 15 through the above-mentioned elimination signal line 23 arranged at the display panel 11.

In the structure of the above-mentioned pixel, operation of the transistors Tr1 and Tr2 is similar to that of the example as shown in FIG. 4. On the other hand, at the timing in the middle of the lighting period of the above-mentioned EL element E1 (in the middle of one sub-frame period, in this preferred embodiment), the elimination pulse Erase which turns on the transistor Tr3 is supplied from the above-mentioned elimination driver 15 through the elimination signal line 23 to a gate of the elimination transistor Tr3.

Thus, the electric charge charged in the capacitor C1 is eliminated (discharged) instantly. As a result, the drive transistor Tr2 is in a cutoff state, and the EL element E1 is turned off immediately. In other words, the lighting period in one sub-frame of the EL element E1 is controlled by controlling the output timing of the elimination pulse Erase from the elimination driver 15, whereby multi-gradation expression can be realized.

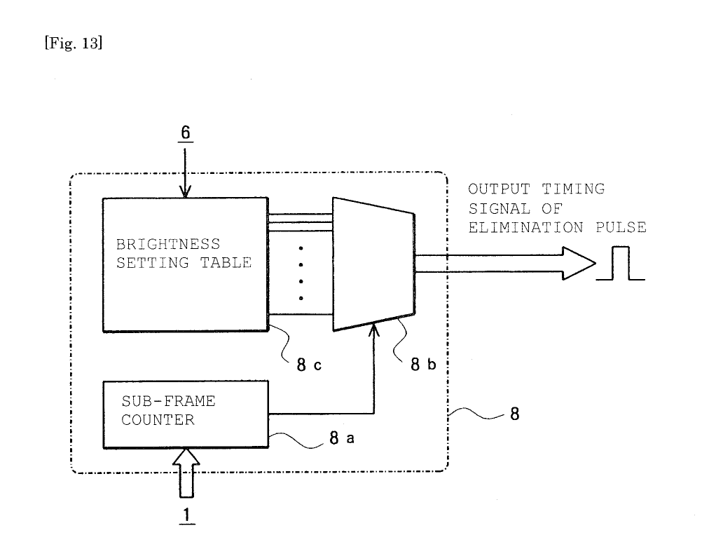

FIG. 12 explains the PLE control, in the video display area, carried out by the structure as shown in FIGS. 10 and 11. When realizing this PLE control, the control means is employed in which one frame period is divided into a plurality of sub-frames, and the lighting periods of the pixels within one frame period are summed by selecting the sub-frames, to thereby realize the gradation control.

In other words, in order to simplify the description, the example shown in FIG. 12 illustrates an example in which one frame period is divided into seven sub-frames (SF1-SF7), and eight gradation expressions (it is possible to assume that 100% non-lighting is also one gradation, leading to 7+1 gradation expressions) are realized by choosing each sub-frame in one frame period.

FIGS. 12, (a) and (b) show an example in which a rate between the lighting period and the non-lighting period for every sub-frame is controlled based on the brightness control data from the above-mentioned brightness control means 6. (a) shows a case where the rate of the lighting period for every sub-frame is large, and (b) shows the case where the rate of the lighting period for every sub-frame is small. In addition, it is shown by way of example that both the above-mentioned (a) and (b) have the same gamma value of the gradation characteristic, and dimmer characteristics are varied.

Here, the control is carried out such that, in the case where the lighting rate of the pixel in the video display area is low, lighting control as shown in FIG. 12(a) in the video display area is performed, and in the case where the lighting rate of the pixel in the video display area is high, the lighting control as shown in FIG. 12(b) in the video display area is performed. In short, according to the extent of the lighting rate of the pixel, it is controlled so that the rate of the lighting period for every sub-frame changes between FIGS. 12 (a) and (b). Thus, especially in the case where the lighting rate of the pixel is high, a summation of the lighting periods of the pixels within one frame period is reduced, and it is possible to decrease a value of the drive current supplied to each pixel.

FIGS. 12 (c) and (d) are for explaining timings at which the above-mentioned write-in pulse and elimination pulse are generated in the case of realizing the lighting control as shown in FIG. 12 (b). In other words, in the example as shown in FIG. 12, the write-in pulse shown in (c) is generated synchronizing with the start of each sub-frame, to thereby cause the pixel to be in the lighting state. In the middle of progress of the sub-frame, the elimination pulse shown as (d) takes place, whereby the pixel is caused to be in a non-lighting state.

Now, in the case of trying to realize “gradation 8”, a series of pixel lighting patterns as shown in FIG. 12 (a) or (b) are performed in one frame period. Further, for example, in the case of trying to realize “gradation 5”, a lighting drive operation is performed during the periods of Sf1-Sf4 as shown in FIG. 12 (a) or (b), and all of subsequent periods Sf5-Sf7 of each sub-frame are caused to be in a light putting-out state. Thus, it is possible to obtain the emission brightness according to the summation of the lighting periods of the pixels in one frame period.

The elimination pulse as shown in FIG. 12 (d) can be generated with the elimination timing signal generation means 8 as shown in FIG. 13 to be explained below. Reference sign 8a in FIG. 13 shows a sub-frame counter, reference sign 8b indicates a logical operation unit, and reference sign 8c denotes a brightness setting table. In other words, based on the synchronization signal from a controller 1, the sub-frame counter 8a operates so that the control signal synchronized with the sub-frame may be supplied to logical operation unit 8b.

Further, the above-mentioned brightness setting table 8c is supplied with the brightness control (PLE control) data from the above-mentioned brightness control means 6, and a suitable brightness setting table is selected based on the brightness control data. It should be noted that the lighting period for every sub-frame is stored in the selected brightness setting table 8c as a parameter.

In the case where a sub-frame number with which lighting control should be carried out is supplied from the sub-frame counter 8a to the logical operation unit 8b, the logical operation unit 8b accesses the selected table, and operates to generate an output timing signal of the elimination pulse based on the parameter of the lighting time which is stored corresponding to the sub-frame number.

This is generated as the output timing signal of the elimination pulse for every sub-frame respectively corresponding to the lighting rate of the pixel in the video display area, as shown in FIG. 12 (d). This timing signal is supplied to the above-mentioned elimination driver 15, and it operates so that the elimination pulse may be outputted from the elimination driver 15 for every sub-frame, as described above.

According to the above-mentioned preferred embodiment, in a situation where a specific gamma characteristic is given, it operates so that the PLE control may be performed based on the lighting rate of the pixel in the video display area. It should be noted that the above-mentioned elimination driver 15 performs elimination operation corresponding to the video display area, whereby the brightness control of the video display area is performed. In other words, in the non-video display area, the elimination operation by the elimination driver 15 is not performed, but the pixel corresponding to the non-video display area is caused to have the gradation based on the input image signal.

It should be noted that also in the preferred embodiment as shown in FIGS. 10-13, the video display area and the non-video display area are divided along the arrangement direction of the elimination signal lines 23 arranged at the display panel 11. In other words, in the case where the arrangement direction of the elimination signal lines 23 is the horizontal direction like the display panel 11 as shown in FIG. 10, the video display area B and the non-video display area C are divided along the line in the horizontal direction in the display plane A as shown in FIG. 8.

Therefore, configuration of the scanning lines 21, the data lines 22, and the elimination signal lines 23 which are shown in FIG. 10 is arranged to be rotated by 90 degrees (for example) as it is on the display panel 11, whereby the video display area B and the non-video display area C may be arranged to be divided along the line in the horizontal direction in the display plane A as shown in FIG. 7.

1-35. (canceled)

36. An image signal display control apparatus in which pixels are arranged in respective intersecting positions where a plurality of data lines and a plurality of scanning lines intersect, and an image is displayed by selectively lighting and driving said pixels based on an input image signal, characterized by comprising a brightness control means for variably controlling emission brightness in said video display area according to a lighting rate of the pixel in the video display area within said displayed image, and
further comprising:
a video display area setting means for setting up the video display area in said displayed image, and
a lighting rate calculation means for calculating a lighting rate of the pixel in the video display area set up by said video display area setting means, wherein
said brightness control means is arranged to variably control the emission brightness of said video display area according to the lighting rate of the pixel calculated by said lighting rate calculation means, and
by detecting a still image area within said image to be displayed, said video display area setting means sets an area other than said still image area within said displayed image as said video area.

37. The image signal display control apparatus as claimed in claim 36, characterized in that said brightness control means is arranged to supply a power supply line connected to the pixel corresponding to said video display area with a drive voltage which is varied according to said lighting rate, and supply a power supply line connected to the pixel corresponding to a non-video display area with a drive voltage of a predetermined value.

38. The image signal display control apparatus as claimed in claim 36, characterized in that said video display area setting means is arranged to set up said video display area by specifying a predetermined display area corresponding to each of said pixels, or by detecting time change of the input image signal corresponding to each of said pixels, and
said brightness control means is arranged to supply a power supply line connected to the pixel corresponding to said video display area with a drive voltage which is varied according to said lighting rate, and supply a power supply line connected to the pixel corresponding to a non-video display area with a drive voltage of a predetermined value.

39. The image signal display control apparatus as claimed in claim 37, characterized in that said power supply line is arranged to be supplied, through a selection means, with the drive voltage which is varied according to said lighting rate or the drive voltage of the predetermined value.

40. The image signal display control apparatus as claimed in claim 38, characterized in that said power supply line is arranged to be supplied, through a selection means, with the drive voltage which is varied according to said lighting rate or the drive voltage of the predetermined value.

41. The image signal display control apparatus as claimed in claim 36, characterized by comprising a light putting-out scanning means for controlling the pixel to be lit and corresponding to said video display area to be in a situation where it is not lit (light is put out) in the middle of one frame or one sub-frame period, wherein said brightness control means is arranged to control a timing of light putting-out operation in said light putting-out scanning means according to said lighting rate.

42. The image signal display control apparatus as claimed in claim 36, characterized in that said video display area setting means is arranged to set up said video display area by specifying a predetermined display area corresponding to each of said pixels, or by detecting time change of the input image signal corresponding to each of said pixels,
a light putting-out scanning means is provided for controlling the pixel to be lit and corresponding to said video display area to be in a situation where it is not lit (light is put out) in the middle of one frame or one sub-frame period, and
said brightness control means is arranged to control a timing of light putting-out operation in said light putting-out scanning means according to said lighting rate.

43. The image signal display control apparatus as claimed in claim 41, characterized in that the pixel corresponding to a non-video display area is arranged not to perform a light putting-out operation by said light putting-out scanning means.

44. The image signal display control apparatus as claimed in claim 42, characterized in that the pixel corresponding to a non-video display area is arranged not to perform a light putting-out operation by said light putting-out scanning means.

45. An image signal display control method, in which pixels are arranged in respective intersecting positions where a plurality of data lines and a plurality of scanning lines intersect, and an image is displayed by selectively lighting and driving said pixels based on an input image signal, characterized in that
a video display area setting operation of setting up a video display area in said displayed image,
a lighting rate calculation operation of calculating a lighting rate of the pixels in the video display area which is set up by said video display area setting operation, and
a brightness control operation of variably controlling emission brightness in said video display area according to the lighting rate calculated by said lighting rate calculation operation are implemented, and
said video display area setting operation is carried out by detecting a still image area within said image to be displayed so that an area other than said still image area within said displayed image is set as said video area.

46. The image signal display control method as claimed in claim 45, characterized in that a power supply line connected to the pixel corresponding to said video display area is supplied with a drive voltage which is varied according to said lighting rate, and a power supply line connected to the pixel corresponding to a non-video display area is supplied with a drive voltage of a predetermined value, to thereby perform variable control of the emission brightness of said video display area.

47. The image signal display control method as claimed in claim 45, characterized in that said video display area setting operation is carried out by specifying a predetermined display area corresponding to each of said pixels, or by detecting time change of the input image signal corresponding to each of said pixels,
a power supply line connected to the pixel corresponding to said video display area is supplied with a drive voltage which is varied according to said lighting rate, and a power supply line connected to the pixel corresponding to a non-video display area is supplied with a drive voltage of a predetermined value, to thereby perform variable control of the emission brightness of said video display area.

48. The image signal display control method as claimed in claim 45, characterized in that a timing of light putting-out operation at which the pixel to be lit and corresponding to said video display area is controlled to be in a situation where it is not lit in the middle of one frame or one sub-frame period, is controlled according to said lighting rate, to thereby perform variable control of the emission brightness of said video display area.

49. The image signal display control method as claimed in claim 45, characterized in that said video display area setting operation is carried out by specifying a predetermined display area corresponding to each of said pixels, or by detecting time change of the input image signal corresponding to each of said pixels,
a timing of light putting-out operation at which the pixel to be lit and corresponding to said video display area is controlled to be in a situation where it is not lit in the middle of one frame or one sub-frame period, is controlled according to said lighting rate, to thereby perform variable control of the emission brightness of said video display area.
